(19) United States
(12) Patent Application Publication
(10) Pub. No.: US 2026/0089548 A1
(43) Pub. Date: Mar. 26, 2026

(54) RECOMMENDED BIT RATE (RBR) MEDIUM ACCESS CONTROL (MAC) CONTROL ELEMENT (CE)

(71) Applicant: QUALCOMM Incorporated, San Diego, CA (US)

(72) Inventors: Linhai HE, San Diego, CA (US); Liangping MA, San Diego, CA (US)

(21) Appl. No.: 18/898,482

(22) Filed: Sep. 26, 2024

(51) Int. Cl. H04W 28/02; H04W 28/22

(52) U.S. Cl. CPC H04W 28/0268; H04W 28/22

(57) ABSTRACT

A wireless node may one or more memories, individually or in combination, having instructions. A wireless node may one or more processors, individually or in combination, configured to execute the instructions and cause the wireless node to: obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicate according to a second bit rate that is based on the first bit rate and the at least one metric.

### BACKGROUND

### Technical Field

The present disclosure generally relates to communication systems, and more particularly, to the communication of recommended bit rates (RBRs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples, the apparatus includes one or more memories, individually or in combination, having instructions and one or more processors, individually or in combination, configured to execute the instructions. In some examples, the one or more processors are configured to obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the one or more processors are configured to communicate according to a second bit rate that is based on the first bit rate and the at least one metric.

Aspects are directed to an apparatus for wireless communication. In some examples, the apparatus includes one or more memories, individually or in combination, having instructions and one or more processors, individually or in combination, configured to execute the instructions. In some examples, the one or more processors are configured to output a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the one or more processors are configured to communicate according to a second bit rate that is based on the first bit rate and the at least one metric.

Aspects are directed to a method for wireless communications at a wireless node. In some examples, the method includes obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the method includes communicating according to a second bit rate that is based on the first bit rate and the at least one metric.

Aspects are directed to a method for wireless communications at a wireless node. In some examples, the method includes outputting a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the method includes communicating according to a second bit rate that is based on the first bit rate and the at least one metric.

Aspects are directed to an apparatus. In some examples, the apparatus includes means for obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the apparatus includes means for communicating according to a second bit rate that is based on the first bit rate and the at least one metric.

Aspects are directed to an apparatus. In some examples, the apparatus includes means for outputting a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the apparatus includes means for communicating according to a second bit rate that is based on the first bit rate and the at least one metric.

Aspects are directed to a non-transitory computer-readable medium comprising instructions that, when executed by a wireless node, cause the wireless node to perform a method. In some examples, the method includes obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the method includes communicating according to a second bit rate that is based on the first bit rate and the at least one metric.

Aspects are directed to a non-transitory computer-readable medium comprising instructions that, when executed by a wireless node, cause the wireless node to perform a method. In some examples, the method includes outputting a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. In some examples, the method includes communicating according to a second bit rate that is based on the first bit rate and the at least one metric.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating examples of a first non-legacy recommended bit rate (RBR) medium access control (MAC) control element (CE) and a second non-legacy RBR MAC CE.

FIG. 6 is a block diagram illustrating examples of a first non-legacy RBR MAC CE and a second non-legacy RBR MAC CE.

FIG. 7 is a flowchart of a method of wireless communication.

FIG. 8 is a diagram illustrating an example of a hardware implementation for an example apparatus.

FIG. 9 is a flowchart of a method of wireless communication.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some examples of wireless communication, a medium access control (MAC) control element (CE) may be used by a network to transmit information to a user equipment (UE). In some examples, a MAC-CE may provide information about a recommended bit rate (RBR), which is configured to indicate an available bit rate for a logical channel. Such a MAC-CE may be used to indicate RBR in either the downlink or uplink direction. In some cases, a UE may transmit, to the network, a request for an available bit rate for a particular logical channel. In response, the network may transmit an RBR MAC-CE to the UE. In addition, the network may also send an RBR MAC-CE without a request from the UE. For example, when available bit rate changes by more than a threshold amount.

In some examples, an application (e.g., extended reality (XR) application executed on a UE) may be capable of rate adaptation. This means that the application may monitor the quality of a network connection and dynamically adjust its coding rates to match what is provided by the network connection. Accordingly, rate adaptation by an application may ensure a consistent user experience. Typically, the cellular link is the bottleneck for such applications. Thus, the application may use an RBR provided by a MAC CE in order to perform rate adaptation. That is, the application may match its encoding rate with the network connection bit rate as indicated by the MAC CE.

However, the current implementation of an RBR MAC CE was intended for voice-over-IP applications. As a result, the current RBR MAC CE implementation suffers from significant quantization error and an overly-broad granularity. For example, the bit rate range currently supported by the MAC CE is between 0 and 8000 kbps, coded by 56 code points in a constant step size. With this rage and code point, the quantization error is up to 22%. Such a high error is representative of a significant difference between the actual bit rate value and the quantized value.

Moreover, the granularity of the RBR is per logical channel. However, there can be multiple QoS flows multiplexed within the same logical channel, and in some examples, it is desirable for a UE to control a bit rate on a per-QoS flow basis instead of per logical channel.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

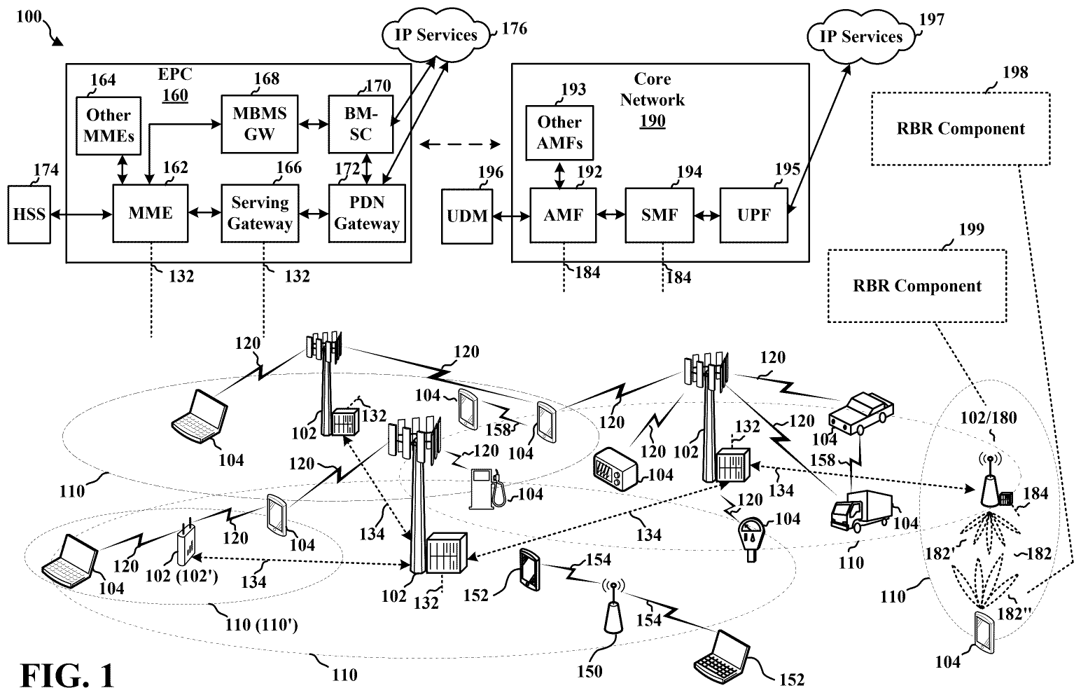

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a RBR component 198. As described in more detail elsewhere herein, the RBR component 198 may be configured to: obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicate according to a second bit rate that is based on the first bit rate and the at least one metric. Additionally, or alternatively, the RBR component 198 may perform one or more other operations described herein.

The base station 102/180 may include a RBR component 199. As described in more detail elsewhere herein, the RBR component 199 may be configured to: output a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicate according to a second bit rate that is based on the first bit rate and the at least one metric. Additionally, or alternatively, the RBR component 199 may perform one or more other operations described herein.

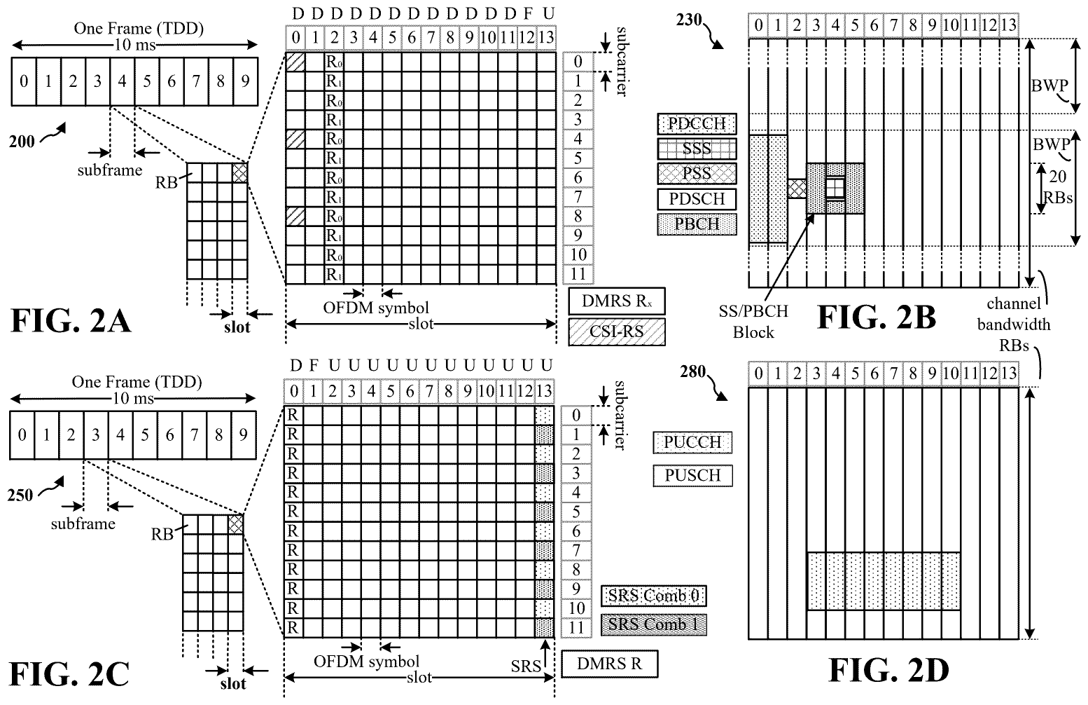

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

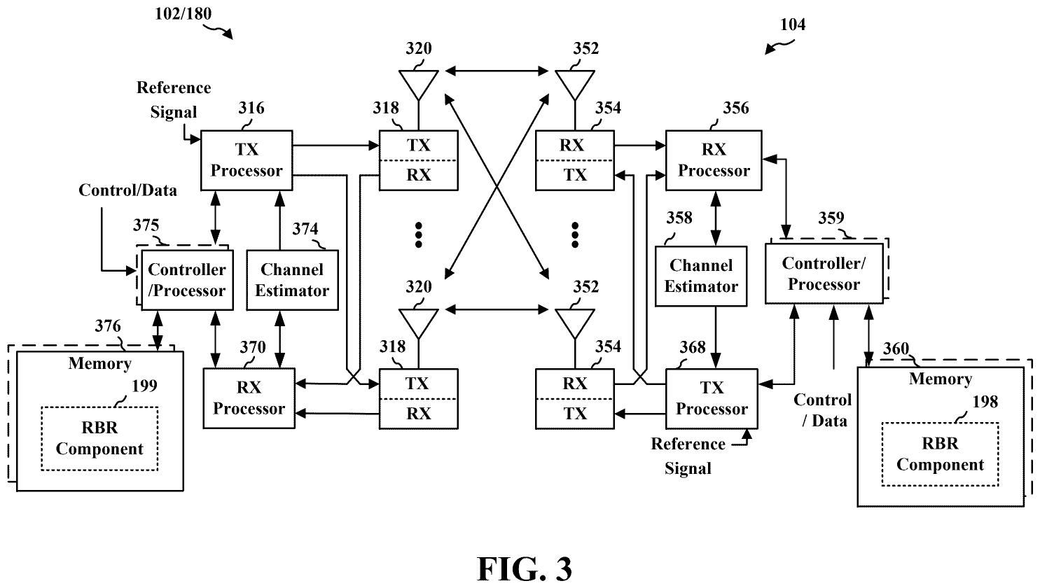

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

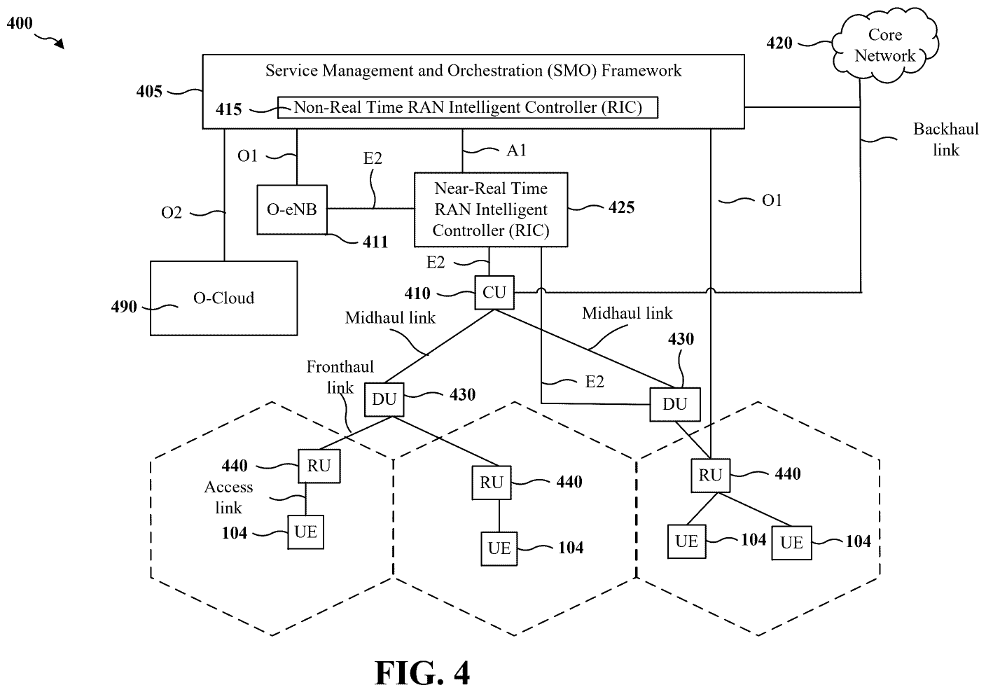

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open cNB (O-CNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Examples of an Enhanced Recommended Bit Rate (RBR) Medium Access Control (MAC) Control Element (CE)

A recommended bit rate (RBR) medium access control (MAC) control element (CE) is a signal that a network entity may use to inform a user equipment (UE) of an available bit rate for a logical channel (LCH). In some examples, the bit rate is configured to indicate a number of bits that can be processed and/or transferred per unit of time, and it may be used to measure the speed or bandwidth of a communication link between the network entity and the UE. A logical channel, on the other hand, is a path or link in a network where data transfer takes place.

In some examples, the network entity may be triggered to transmit the RBR MAC CE by a request for an RBR MAC CE transmitted from the UE. Here, the UE may transmit a request to the network entity, and in response, the network entity may transmit the RBR MAC CE to the UE. In another example, the network entity may be triggered to transmit the RBR MAC CE in response to a threshold condition being satisfied. Here, if the bit rate associated with a particular logical channel changes by a threshold amount (e.g., 5%), then the network entity may transmit an RBR MAC CE indicating a current RBR to the UE in response to the threshold condition being satisfied.

In certain aspects, a non-legacy RBR MAC CE may be used to overcome shortcomings of the existing (e.g., legacy) RBR MAC CE. That is, the non-legacy MAC CE may reduce or eliminate the quantization error associated with the legacy MAC CE, and/or improve the granularity associated with the legacy MAC CE by introducing bit rate control on a QoS flow level in addition to a logical channel level. As used herein, a “legacy” MAC CE may relate to an RBR MAC CE as defined by 3GPP standard Release 18 and earlier. Accordingly, a “non-legacy” MAC CE relates to an RBR MAC CE as defined by 3GPP standard Release 19 and later.

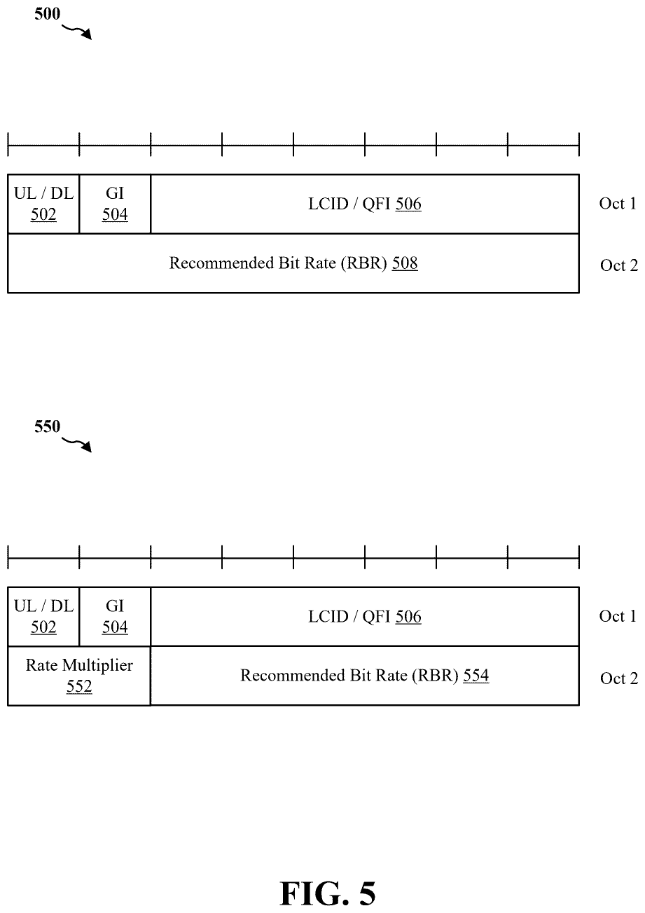

FIG. 5 is a block diagram illustrating examples of a first non-legacy RBR MAC CE 500 and a second non-legacy RBR MAC CE 550. In some examples, one of the first non-legacy RBR MAC CE 500 and/or the second non-legacy RBR MAC CE 550 may replace the legacy RBR MAC CE.

The first non-legacy RBR MAC CE 500 includes a first octet row (Oct 1) and a second octet row (Oct 2). The first row includes a direction (uplink/downlink) indicator 502 configured to indicate whether the RBR indicated in the first non-legacy RBR MAC CE 500 applies to uplink communications or downlink communications. The first row also includes a granularity indicator (GI) 504 configured to indicate whether the indicated RBR is intended for a logical channel or a QoS flow. The first row also includes an identifier field 506 configured to indicate a logical channel identifier (LCID) or a QoS flow identifier (QFI). In some examples, the identifier field 506 may be configured to identify the target logical channel or the target QoS flow corresponding to the RBR. In some examples, whether the identifier field 506 identifies the target logical channel or the target QoS flow may depend on the value indicated by the GI 504. The direction indicator 502 and the GI 504 may each be indicated by a 1-bit field, while the identifier field 506 may be up to a 6-bit field.

The second row includes an RBR field 508 configured to indicate an RBR. This field may be coded by at least 8 or more bits using an exponential distribution or a linear distribution. That is, in order to determine the actual bit rate indicated by the RBR field 508, the UE may need to perform certain computations. For example, if the distribution is an exponential distribution, and the value of an RBR field 508 is value k, then the actual bit rate (Rₖ) can be determined based on the following equation:

$${R}_{k} = M \times {R}_{min} \times {( 1 + q )}^{k} , \qquad Equation 1$$

$$where q = {( {R}_{max} / {R}_{min} )}^{( 1 / N )} - 1$$

Here, M is a multiplier (e.g., an integer or whole number), q is a quantization error computed based on a maximum bit rate (Rₘₐₓ), a minimum bit rate (Rₘᵢₙ), and a total number of code points (N). Parameters M, Rₘₐₓ, and Rₘᵢₙ may be predefined in a wireless standard, and/or configured by the network via RRC messaging. Accordingly, an exponential distribution relates to a scenario where a bit rate cumulatively increases at each successive code point by a fixed rate (e.g., percentage). For example, a bit rate corresponding to each code point may increase by 10% relative to a previous codepoint. In this example, code point 1 corresponds to 1 Mbps, and thus, code point 2 corresponds to 1.1 Mbps, and code point 3 corresponds to 1.21 Mbps, etc.

If the distribution is a linear distribution, and the value of an RBR field 508 is value k, then the actual bit rate (Rₖ) can be determined based on the following equation:

$${R}_{k} = M \times [ {R}_{min} + k ( {R}_{max} - {R}_{min} ) / N ] , \qquad Equation 2$$

Here, a linear distribution relates to a constant increase/decrease in bit rate for each code point. For example, if code point 1 corresponds to a 1 Mbps bit rate, then code point 2 may correspond to 1.5 Mbps, and code point 3 may correspond to 2.0 Mbps, etc. In this example, the bit rate increases at a constant rate of 0.5 Mbps at each successive code point relative to a previous codepoint.

In one example, a network entity may transmit an indication of a rate multiplier within a non-legacy RBR MAC CE. For example, the second row of the second non-legacy RBR MAC CE 550 may include: (i) a rate multiplier field 552 configured to indicate a multiplier value, and (ii) a relatively shorter (e.g., 6-bit) RBR field 554. Accordingly, the UE may determine an actual bit rate by multiplying the rate multiplier value indicated in the rate multiplier field 552 by the bit rate value indicated in the RBR field 554.

In certain aspects, the first non-legacy RBR MAC CE 500 and the second non-legacy RBR MAC CE 550 may be used in conjunction with a legacy RBR MAC CE. For example, a network entity may transmit a legacy RBR MAC CE to the UE, wherein the legacy RBR MAC CE provides an indication of an RBR. After transmitting the legacy RBR MAC CE, the network entity may transmit one of the first non-legacy RBR MAC CE 500 or the second non-legacy RBR MAC CE 550. Here, the RBR field 508/554 of the non-legacy RBR MAC CE may provide information used to further refine the RBR provided by the legacy RBR MAC CE. In other words, the UE may use the RBR field 508/554 information of the non-legacy RBR MAC CE along with the RBR information provided by the legacy RBR MAC CE to determine an actual bit rate.

For example, if the RBR field of the legacy RBR MAC CE has a value of m, and the RBR field 508/554 of the non-legacy RBR MAC CE has a value of n, then the actual bit rate (Rₙ) can be determined based on the following equation:

$${R}_{n} = {R}_{m} \times {( 1 + p )}^{n} , \qquad Equation 3$$

$$where p = {( {R}_{m + 1} / {R}_{m} )}^{( 1 / L )} - 1$$

Where L is the length of the RBR field 508/554 of the non-legacy RBR MAC CE, and Rₘ is the bit rate corresponding to the value m in the RBR field of the legacy MAC CE. Thus, in such an example, the non-legacy RBR MAC CE may be used as signaling that is supplemental to a legacy RBR MAC CE.

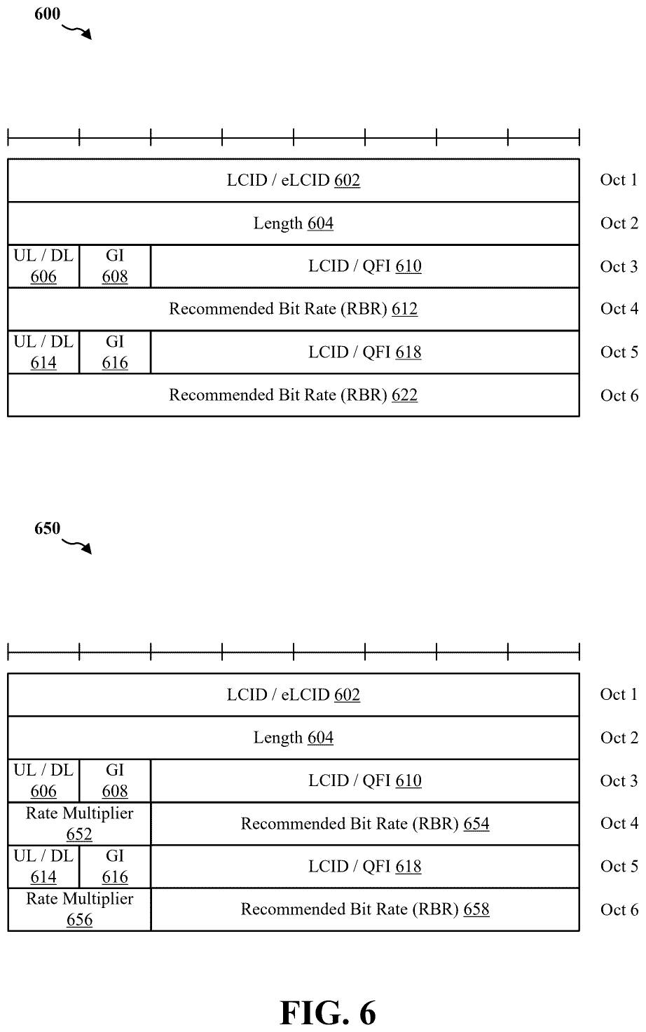

FIG. 6 is a block diagram illustrating examples of a first non-legacy RBR MAC CE 600 and a second non-legacy RBR MAC CE 650. In some examples, one of the first non-legacy RBR MAC CE 600 and/or the second non-legacy RBR MAC CE 650 may replace the legacy RBR MAC CE.

The first non-legacy RBR MAC CE 600 includes six octet rows (Oct 1-6). However, it should be noted that the illustrated configuration is an example of a non-legacy RBR MAC CE that is configured to indicate multiple RBRs, with each RBR associated with a different one of two separate logical channels and/or QoS flows. Accordingly, the non-legacy RBR MAC CEs illustrated in FIG. 6 may include any suitable number of rows (e.g., 4 rows, 8 rows, etc.). As shown, the non-legacy RBR MAC CEs 600/650 may provide the UE with an RBR for multiple different logical channels and/or QoS flows in a single MAC CE.

The first row (Oct 1) may include an identifier field 602 configured to provide an indication of a logical channel identifier (LCID) or an extended logical channel identifier (CLCID). The second row (Oct 2) may include a length field 604 configured to indicate a number of logical channels and/or QoS flows included in the non-legacy RBR MAC CE. In some examples, the length field 604 is configured to indicate the number of logical channels and/or QoS flows multiplied by a number of octets per logical channel and/or QoS flow.

The third row (Oct 3) includes a direction (uplink/downlink) indicator 606 configured to indicate whether the RBR indicated in the first non-legacy RBR MAC CE 600 applies to uplink communications or downlink communications. The third row also includes a granularity indicator (GI) 608 configured to indicate whether the indicated RBR is intended for a logical channel or a QoS flow. The third row also includes an identifier field 610 configured to indicate a logical channel identifier (LCID) or a QoS flow identifier (QFI). In some examples, the identifier field 610 may be configured to identify the target logical channel or the target QoS flow corresponding to the RBR. In some examples, whether the identifier field 610 identifies the target logical channel or the target QoS flow may depend on the value indicated by the GI 608. The direction indicator 606 and the GI 608 may each be indicated by a 1-bit field, while the identifier field 610 may be up to a 6-bit field.

The fourth row (Oct 4) includes an RBR field 612 configured to indicate an RBR. This field may be coded by at least 8 or more bits using an exponential distribution or a linear distribution. Thus, the actual bit rate indicated by the RBR field 612 may be computed using the processes described above in connection with FIG. 5.

The fifth row (Oct 5) provides additional direction (uplink/downlink) indicator 614 and granularity indicator (GI) 616 corresponding to a logical channel and/or QoS flow identified in an identifier field 618. In some examples, the identifier field 610 may be configured to identify the target logical channel or the target QoS flow corresponding to the RBR. The sixth row (Oct 6) includes an additional RBR field 622 configured to indicate an RBR associated with the values indicated in the fifth row.

The pair of rows including the third row (Oct 3) and fourth row (Oct 4), as well as the pair of rows including the fifth row (Oct 5) and the sixth row (Oct 6) of the first non-legacy RBR MAC CE 600 of FIG. 6 are similar to the pair of rows including the first row (Oct 1) and second row (Oct 2) of the first non-legacy RBR MAC CE 500 of FIG. 5.

The second non-legacy RBR MAC CE 650 includes six octet rows (Oct 1-6) similar to the first non-legacy RBR MAC CE 600. However, the second non-legacy RBR MAC CE 650 further includes a rate multiplier field 652/656 configured to provide the UE with a multiplier, similar to the second non-legacy RBR MAC CE 550 of FIG. 5. The rate multiplier fields may reduce the bit-size of the corresponding RBR fields 654/658 relative to the bit size of the RBR fields 612/622 of the first non-legacy RBR MAC CE 600.

Thus, the first non-legacy RBR MAC CE 600 and the second non-legacy RBR MAC CE 650 may be configured to provide the UE with an indication of an RBR for each of multiple logical channels and/or multiple QoS flows in a single MAC CE. Such a configuration may provide for adaptation of multiple QoS flows at the same time.

It should be noted that, while FIGS. 5 and 6 illustrated examples of MAC CEs having fields with defined bit sizes, such fields may be defined by any suitable bit length.

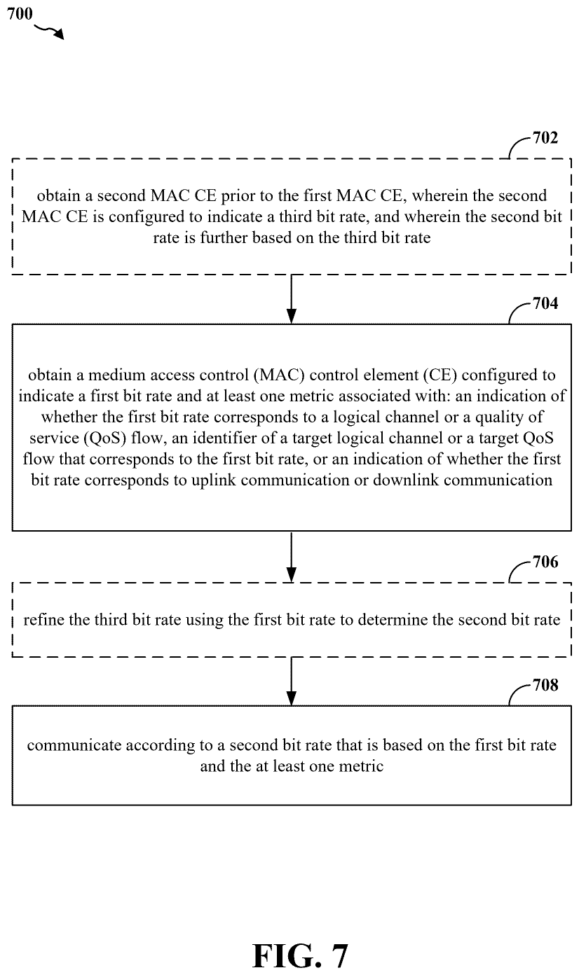

FIG. 7 is a flowchart 700 of a method of wireless communication. The method may be performed by a UE (e.g., the UE 104; the apparatus 802). Specifically, the method may be performed by one or more memories, processors, and RF front ends (e.g., the memory 360, controller/processor 359, transmitter 354TX, receiver 354RX, antenna 352 of FIG. 3).

At 702, the UE may optionally obtain a second MAC CE prior to the first MAC CE, wherein the second MAC CE is configured to indicate a third bit rate, and wherein the second bit rate is further based on the third bit rate. For example, 702 may be performed by an obtaining component 840. In certain aspects, the UE may refine the third bit rate using the first bit rate to determine the second bit rate. In certain aspects, the first bit rate is defined by an exponential distribution or a linear distribution.

At 704, the UE may obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. For example, 704 may be performed by the obtaining component 840.

At 706, the UE may optionally refine the third bit rate using the first bit rate to determine the second bit rate. For example, 706 may be performed by the refining component 842. In certain aspects, the first bit rate is defined by an exponential distribution or a linear distribution.

Finally, at 708, the UE may communicate according to a second bit rate that is based on the first bit rate and the at least one metric. For example, 708 may be performed by a combination of the obtaining component 840 and an outputting component 844.

In certain aspects, the MAC CE comprises a sub header via which a logical channel identifier (LCID) is indicated.

In certain aspects, the at least one metric comprises a logical channel identifier (LCID) indicated via: a 6-bit LCID value, an 8-bit extended LCID (eLCID) value, or a 16-bit eLCID value.

In certain aspects, the MAC CE is further configured to indicate a rate multiplier, and wherein the second bit rate is further based on the rate multiplier.

In certain aspects, the at least one metric comprises multiple logical channel identifiers (LCIDs), and wherein each of the multiple LCIDs is configured to identify one of a plurality of logical channels.

In certain aspects, the first bit rate is associated with one of the multiple LCIDs.

In certain aspects, the MAC CE is configured to provide multiple QoS flow identifiers, and wherein each of the multiple QoS identifiers is configured to identify one of a plurality of QoS flows.

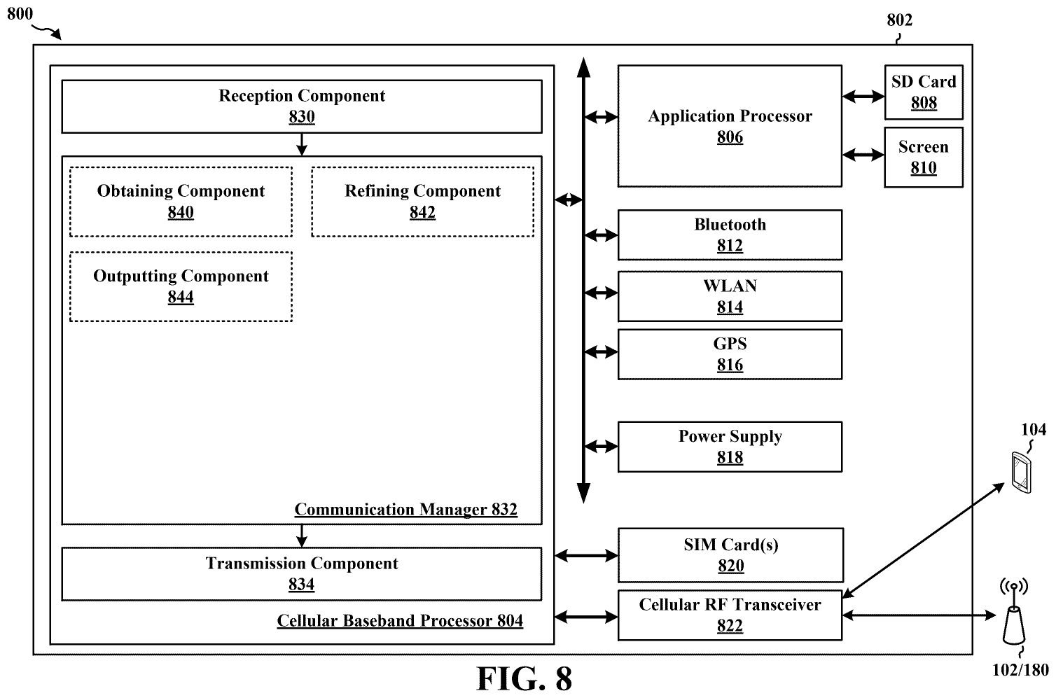

FIG. 8 is a diagram 800 illustrating an example of a hardware implementation for an apparatus 802. The apparatus 802 is a UE and includes a cellular baseband processor 804 (also referred to as a modem) coupled to one or more cellular RF transceivers 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the one or more cellular RF transceivers 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see UE 104 of FIG. 3) and include the aforediscussed additional modules of the apparatus 802. In various examples, the apparatus 802 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 832 includes an obtaining component 840 configured to obtain a second MAC CE prior to the first MAC CE, wherein the second MAC CE is configured to indicate a third bit rate, and wherein the second bit rate is further based on the third bit rate; obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicate according to a second bit rate that is based on the first bit rate and the at least one metric; e.g., as described in connection with 702, 704, and 708.

The communication manager 832 further includes a refining component 842 configured to refine the third bit rate using the first bit rate to determine the second bit rate, e.g., as described in connection with 706.

The communication manager 832 further includes an outputting component 844 configured to communicate according to a second bit rate that is based on the first bit rate and the at least one metric, e.g., as described in connection with 708.

The apparatus may include additional components that perform each of the blocks of the algorithm in the aforementioned flowchart of FIG. 7. As such, each block in the aforementioned flowchart may be performed by a component and the apparatus may include one or more of those components. The components may be one or more hardware components specifically configured to perform the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes: means for obtaining a second MAC CE prior to the first MAC CE, wherein the second MAC CE is configured to indicate a third bit rate, and wherein the second bit rate is further based on the third bit rate; means for obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; means for refining the third bit rate using the first bit rate to determine the second bit rate; and means for communicating according to a second bit rate that is based on the first bit rate and the at least one metric.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for communicating includes the means for receiving/obtaining and means for transmitting/outputting. Means for determining and means for refining may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

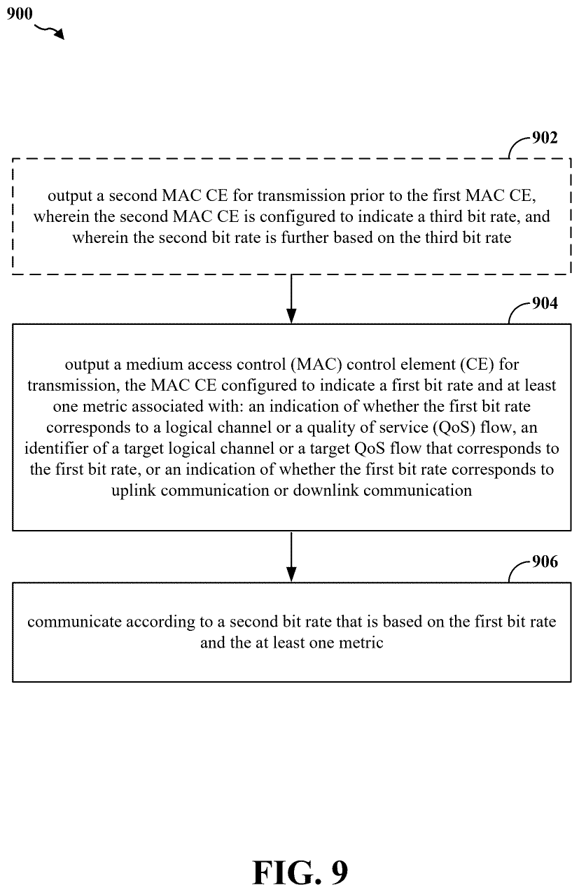

FIG. 9 is a flowchart 900 of a method of wireless communication. The method may be performed by a network entity or base station (e.g., the base station 102/180; the apparatus 1002. Specifically, the method may be performed by one or more memories, processors, and RF front ends (e.g., the memory 376, controller/processor 375, transmitter 318TX, receiver 318RX, antenna 320 of FIG. 3).

At 902, the network entity may optionally output a second MAC CE for transmission prior to the first MAC CE, wherein the second MAC CE is configured to indicate a third bit rate, and wherein the second bit rate is further based on the third bit rate. For example, 902 may be performed by an outputting component 1040.

At 904, the network entity may output a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication. For example, 904 may be performed by the outputting component 1040.

Finally, at 906, the network entity may communicate according to a second bit rate that is based on the first bit rate and the at least one metric. For example, 906 may be performed by a combination of the outputting component 1040 and an obtaining component 1042.

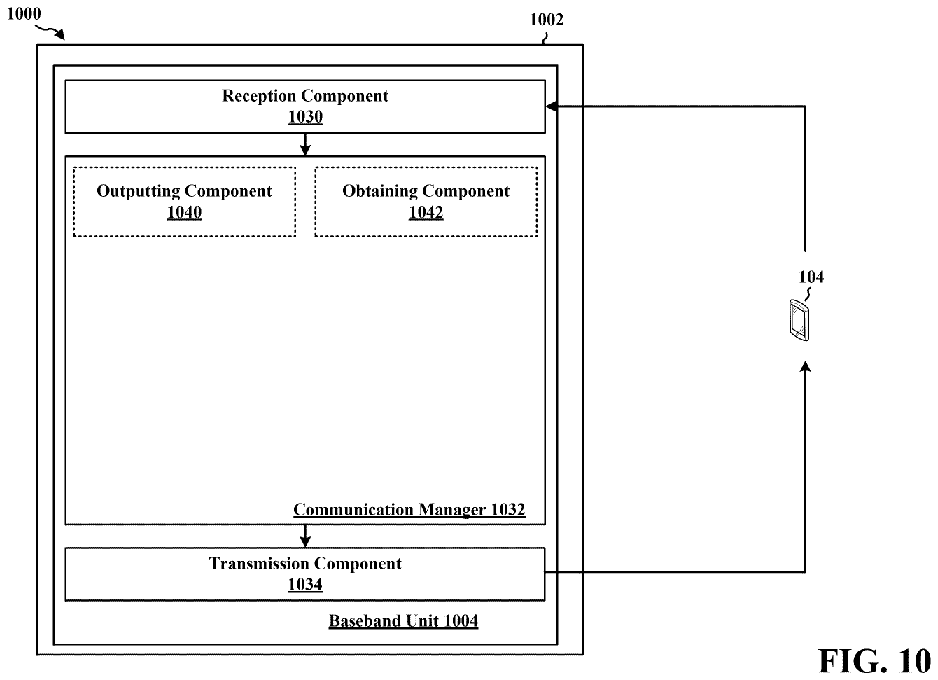

FIG. 10 is a diagram 1000 illustrating an example of a hardware implementation for an apparatus 1002. The apparatus 1002 is a BS and includes a baseband unit 1004. The baseband unit 1004 may communicate through one or more cellular RF transceivers with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an outputting component 1040 configured to: output a second MAC CE for transmission prior to the first MAC CE, wherein the second MAC CE is configured to indicate a third bit rate, and wherein the second bit rate is further based on the third bit rate; output a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicate according to a second bit rate that is based on the first bit rate and the at least one metric; e.g., as described in connection with 902, 904, and 906.

The communication manager 1032 further includes an obtaining component 1042 configured to communicate according to a second bit rate that is based on the first bit rate and the at least one metric, e.g., as described in connection with 906.

The apparatus may include additional components that perform each of the blocks of the algorithm in the aforementioned flowcharts of FIG. 9. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes: means for outputting a second MAC CE for transmission prior to the first MAC CE, wherein the second MAC CE is configured to indicate a third bit rate, and wherein the second bit rate is further based on the third bit rate; means for outputting a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and means for communicating according to a second bit rate that is based on the first bit rate and the at least one metric.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for communicating may include a combination of the means for transmitting/outputting and means for receiving/obtaining. Means for selecting, means for detecting, means for determining, and means for generating may include a processing system, which may include one or more processors, such as the controller/processor 375, the memory 376, and/or any other suitable hardware components of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### ADDITIONAL CONSIDERATIONS

As used herein, the terms “refining” (or any variants thereof) encompass a wide variety of actions. For example, “refining” may include calculating, computing, processing, deriving, investigating, looking up (e.g., looking up in a table, a database or another data structure), ascertaining and the like.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communications at a wireless node, comprising: obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicating according to a second bit rate that is based on the first bit rate and the at least one metric.

Example 2 is the method of Example 1, wherein the MAC CE comprises a sub header via which a logical channel identifier (LCID) is indicated.

Example 3 is the method of any of Examples 1 and 2, wherein the at least one metric comprises a logical channel identifier (LCID) indicated via: a 6-bit LCID value, an 8-bit extended LCID (eLCID) value, or a 16-bit eLCID value.

Example 4 is the method of any of Examples 1-3, wherein the MAC CE is further configured to indicate a rate multiplier, and wherein the second bit rate is further based on the rate multiplier.

Example 5 is the method of any of Example 1-4, wherein the MAC CE is a first MAC CE, and wherein the method further comprises: obtaining a second MAC CE prior to the first MAC CE, wherein the second MAC CE is configured to indicate a third bit rate, and wherein the second bit rate is further based on the third bit rate.

Example 6 is the method of Example 5, wherein the method further comprises: refining the third bit rate using the first bit rate to determine the second bit rate, wherein the first bit rate is defined by an exponential distribution or a linear distribution.

Example 7 is the method of any of Examples 1-6, wherein the at least one metric comprises multiple logical channel identifiers (LCIDs), and wherein each of the multiple LCIDs is configured to identify one of a plurality of logical channels.

Example 8 is the method of Example 7, wherein the first bit rate is associated with one of the multiple LCIDs.

Example 9 is the method of any of Examples 1-8, wherein the MAC CE is configured to provide multiple QoS flow identifiers, and wherein each of the multiple QoS identifiers is configured to identify one of a plurality of QoS flows.

Example 10 is a method for wireless communications at a wireless node, comprising: outputting a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and communicating according to a second bit rate that is based on the first bit rate and the at least one metric.

Example 11 is the method of Example 10, wherein the MAC CE comprises a sub header via which a logical channel identifier (LCID) is indicated.

Example 12 is the method of any of Examples 10 and 11, wherein the at least one metric comprises a logical channel identifier (LCID) indicated via: a 6-bit LCID value, an 8-bit enhanced LCID (ELCID) value, or a 16-bit eLCID value.

Example 13 is the method of any of Examples 10-12, wherein the MAC CE is further configured to indicate a rate multiplier, and wherein the second bit rate is further based on the rate multiplier.

Example 14 is the method of any of Examples 10-13, wherein the MAC CE is a first MAC CE, and wherein the method further comprises: outputting a second MAC CE for transmission prior to the first MAC CE, wherein the second MAC CE is configured to indicate a third bit rate, and wherein the second bit rate is further based on the third bit rate.

Example 15 is the method of Example 14, wherein the first bit rate is configured to refine the third bit rate, wherein the first bit rate is defined by an exponential distribution or a linear distribution.

Example 16 is the method of any of Examples 10-15, wherein the MAC CE is configured to provide multiple LCIDs, wherein each of the multiple LCIDs is configured to identify one of a plurality of logical channels, and wherein the first bit rate is associated with one of the multiple LCIDs.

Example 17 is the method of any of Examples 10-16, wherein the MAC CE is configured to provide multiple QoS flow identifiers, and wherein each of the multiple QoS identifiers is configured to identify one of a plurality of QoS flows.

Example 18 is an apparatus for wireless communications, comprising means for performing a method in accordance with any one of examples 1-9.

Example 19 is an apparatus for wireless communications, comprising means for performing a method in accordance with any one of examples 10-17.

Example 20 is a non-transitory computer-readable medium comprising instructions that, when executed by a wireless node, cause the wireless node to perform a method in accordance with any one of examples 1-9.

Example 21 is a non-transitory computer-readable medium comprising instructions that, when executed by a wireless node, cause the wireless node to perform a method in accordance with any one of examples 10-17.

Example 22 is an apparatus for wireless communications, comprising: one or more memories, individually or in combination, having instructions; and one or more processors, individually or in combination, configured to execute the instructions and cause the apparatus to perform a method in accordance with any one of examples 1-9.

Example 23 is an apparatus for wireless communications, comprising: one or more memories, individually or in combination, having instructions; and one or more processors, individually or in combination, configured to execute the instructions and cause the apparatus to perform a method in accordance with any one of examples 10-17.

Example 24 is a wireless node (e.g., a UE), comprising: one or more transceivers; one or more memories, individually or in combination, having instructions; and one or more processors, individually or in combination, configured to execute the instructions and cause the wireless node to perform a method in accordance with any one of examples 1-9, wherein the one or more transceivers are configured to: receive the MAC CE.

Example 25 is a wireless node (e.g., a network entity), comprising: one or more transceivers; one or more memories, individually or in combination, having instructions; and one or more processors, individually or in combination, configured to execute the instructions and cause the wireless node to perform a method in accordance with any one of examples 10-17, wherein the one or more transceivers are configured to: transmit the MAC CE.

What is claimed is:

1. An apparatus for wireless communication, comprising:
one or more memories, individually or in combination, having instructions; and
one or more processors, individually or in combination, configured to execute the instructions and cause the apparatus to:
obtain a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and
communicate according to a second bit rate that is based on the first bit rate and the at least one metric.

2. The apparatus of claim 1, wherein the MAC CE comprises a sub header via which a logical channel identifier (LCID) is indicated.

3. The apparatus of claim 1, wherein the at least one metric comprises a logical channel identifier (LCID) indicated via: a 6-bit LCID value, an 8-bit extended LCID (eLCID) value, or a 16-bit eLCID value.

4. The apparatus of claim 1, wherein the MAC CE is further configured to indicate a rate multiplier, and wherein the second bit rate is further based on the rate multiplier.

5. The apparatus of claim 1, wherein the MAC CE is a first MAC CE, and wherein the one or more processors are further configured to:
obtain a second MAC CE prior to the first MAC CE, wherein the second MAC CE is configured to indicate a third bit rate, and wherein the second bit rate is further based on the third bit rate.

6. The apparatus of claim 5, wherein the one or more processors are further configured to:
refine the third bit rate using the first bit rate to determine the second bit rate, wherein the first bit rate is defined by an exponential distribution or a linear distribution.

7. The apparatus of claim 1, wherein the at least one metric comprises multiple logical channel identifiers (LCIDs), and wherein each of the multiple LCIDs is configured to identify one of a plurality of logical channels.

8. The apparatus of claim 7, wherein the first bit rate is associated with one of the multiple LCIDs.

9. The apparatus of claim 1, wherein the MAC CE is configured to provide multiple QoS flow identifiers, and wherein each of the multiple QoS identifiers is configured to identify one of a plurality of QoS flows.

10. The apparatus of claim 1, further comprising one or more transceivers configured to:
receive the MAC CE, wherein the apparatus is configured as a user equipment (UE).

11. An apparatus for wireless communication, comprising:
one or more memories, individually or in combination, having instructions; and
one or more processors, individually or in combination, configured to execute the instructions and cause the apparatus to:
output a medium access control (MAC) control element (CE) for transmission, the MAC CE configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and
communicate according to a second bit rate that is based on the first bit rate and the at least one metric.

12. The apparatus of claim 11, wherein the MAC CE comprises a sub header via which a logical channel identifier (LCID) is indicated.

13. The apparatus of claim 11, wherein the at least one metric comprises a logical channel identifier (LCID) indicated via: a 6-bit LCID value, an 8-bit enhanced LCID (eLCID) value, or a 16-bit eLCID value.

14. The apparatus of claim 11, wherein the MAC CE is further configured to indicate a rate multiplier, and wherein the second bit rate is further based on the rate multiplier.

15. The apparatus of claim 11, wherein the MAC CE is a first MAC CE, and wherein the one or more processors are further configured to:
output a second MAC CE for transmission prior to the first MAC CE, wherein the second MAC CE is configured to indicate a third bit rate, and wherein the second bit rate is further based on the third bit rate.

16. The apparatus of claim 15, wherein at least one of: the first bit rate is configured to refine the third bit rate, or the first bit rate is defined by an exponential distribution or a linear distribution.

17. The apparatus of claim 11, wherein the MAC CE is configured to provide multiple LCIDs, wherein each of the multiple LCIDs is configured to identify one of a plurality of logical channels, and wherein the first bit rate is associated with one of the multiple LCIDs.

18. The apparatus of claim 11, wherein the MAC CE is configured to provide multiple QoS flow identifiers, and wherein each of the multiple QoS identifiers is configured to identify one of a plurality of QoS flows.

19. The apparatus of claim 11, further comprising one or more transceivers configured to:
transmit the MAC CE, wherein the apparatus is configured as a network entity.

20. A method for wireless communications at a wireless node, comprising:
obtaining a medium access control (MAC) control element (CE) configured to indicate a first bit rate and at least one metric associated with: an indication of whether the first bit rate corresponds to a logical channel or a quality of service (QoS) flow, an identifier of a target logical channel or a target QoS flow that corresponds to the first bit rate, or an indication of whether the first bit rate corresponds to uplink communication or downlink communication; and
communicating according to a second bit rate that is based on the first bit rate and the at least one metric.
